(19) United States
(12) Patent Application Publication
(10) Pub. No.: US 2014/0222727 A1
(43) Pub. Date: Aug. 7, 2014

(54) ENHANCING THE RELIABILITY OF LEARNING MACHINES IN COMPUTER NETWORKS

(71) Applicant: Cisco Technology, Inc., San Jose, CA (US)

(72) Inventors: Jean-Philippe Vasseur, Saint Martin d'Uriage (FR); Grégory Mermoud, Veyras (CH); Sukrit Dasgupta, Norwood, MA (US)

(73) Assignee: CISCO TECHNOLOGY, INC., San Jose, CA (US)

(21) Appl. No.: 13/937,664

(22) Filed: Jul. 9, 2013

Related U.S. Application Data
(60) Provisional application No. 61/761,129, filed on Feb. 5, 2013.

(51) Int. Cl. G06N 99/00; G06F 11/00

(52) U.S. Cl. CPC G06N 99/005; G06F 11/008
USPC 706/12

(57) ABSTRACT

In one embodiment, network data is processed using a Learning Machine (LM) algorithm in a network, and results of the processing of network data are determined. A reliability checking algorithm is selected to determine a reliability level of the results. The reliability checking algorithm may be a local reliability checking algorithm or an external reliability checking algorithm. The reliability level of the results is determined using the reliability checking algorithm. Then, the LM algorithm is adjusted based on the determined reliability level.

### RELATED APPLICATION

The present invention claims priority to U.S. Provisional Application Ser. No. 61/761,129, filed Feb. 5, 2013, entitled “ENHANCING THE RELIABILITY OF LEARNING MACHINES IN COMPUTER NETWORKS”, by Vasseur, et al., the contents of which are incorporated herein by reference.

### TECHNICAL FIELD

The present disclosure relates generally to computer networks, and, more particularly, to the use of learning machines within computer networks.

### BACKGROUND

Low power and Lossy Networks (LLNs), e.g., Internet of Things (IoT) networks, have a myriad of applications, such as sensor networks, Smart Grids, and Smart Cities. Various challenges are presented with LLNs, such as lossy links, low bandwidth, low quality transceivers, battery operation, low memory and/or processing capability, etc. The challenging nature of these networks is exacerbated by the large number of nodes (an is order of magnitude larger than a “classic” IP network), thus making the routing, Quality of Service (QoS), security, network management, and traffic engineering extremely challenging, to mention a few.

Machine learning (ML) is concerned with the design and the development of algorithms that take as input empirical data (such as network statistics and states, and performance indicators), recognize complex patterns in these data, and solve complex problems such as regression (which are usually extremely hard to solve mathematically) thanks to modeling. In general, these patterns and computation of models are then used to make decisions automatically (i.e., close-loop control) or to help make decisions. ML is a very broad discipline used to tackle very different problems (e.g., computer vision, robotics, data mining, search engines, etc.), but the most common tasks are the following: linear and non-linear regression, classification, clustering, dimensionality reduction, anomaly detection, optimization, association rule learning.

One very common pattern among ML algorithms is the use of an underlying model M, whose parameters are optimized for minimizing the cost function associated to M, given the input data. For instance, in the context of classification, the model M may be a straight line that separates the data into two classes such that M=a*x+b*y+c and the cost function would be the number of misclassified points. The ML algorithm then consists in adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data. Note that the example above is an over-simplification of more complicated regression problems that are usually highly multi-dimensional.

Learning Machines (LMs) are computational entities that rely on one or more ML algorithm for performing a task for which they haven't been explicitly programmed to perform. In particular, LMs are capable of adjusting their behavior to their environment (that is, “auto-adapting” without requiring a priori configuring static rules). In the context of LLNs, and more generally in the context of the IoT (or Internet of Everything, IoE), this ability will be very important, as the network will face changing conditions and requirements, and the network will become too large for efficiently management by a network operator. In addition, LLNs in general may significantly differ according to their intended use and deployed environment.

Thus far, LMs have not generally been used in LLNs, despite the overall level of complexity of LLNs, where “classic” approaches (based on known algorithms) are inefficient or when the amount of data cannot be processed by a human to predict network behavior considering the number of parameters to be taken into account. Note also that LLNs bring another set of challenges, considering their constrained nature; thus it becomes difficult to retrieve large amounts of data, run CPU intensive algorithms on constrained devices to mention a few challenges.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example directed acyclic graph (DAG) in the communication network of FIG. 1; and

FIG. 4 illustrates an example simplified procedure for enhancing the reliability of learning machines in computer networks.

### DESCRIPTION OF EXAMPLE EMBODIMENTS

### Overview

According to one or more embodiments of the disclosure, techniques are shown and described relating to enhancing the reliability of learning machines in computer networks. In one embodiment, network data is processed using a Learning Machine (LM) algorithm in a network, and results of the processing of network data are determined. A reliability checking algorithm is selected to determine a reliability level of the results. The reliability checking algorithm may be a local reliability checking algorithm or an external reliability checking algorithm. The reliability level of the results is determined using the reliability checking algorithm. Then, the LM algorithm is adjusted based on the determined reliability level.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

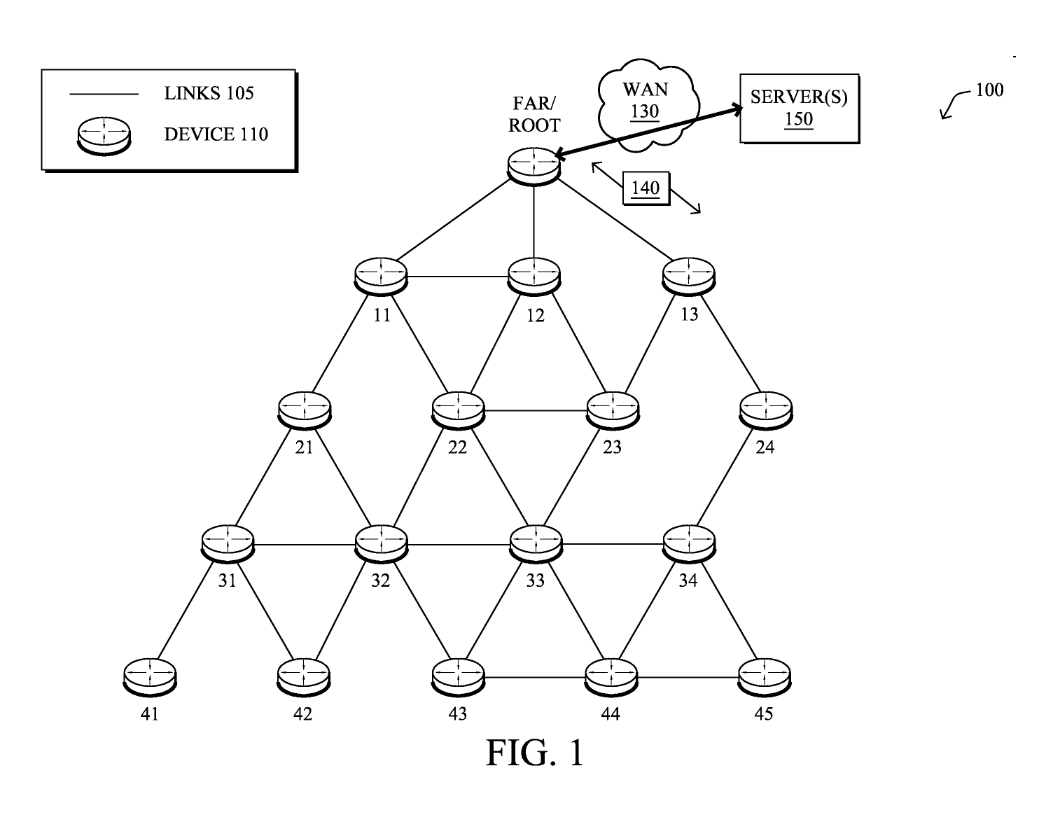

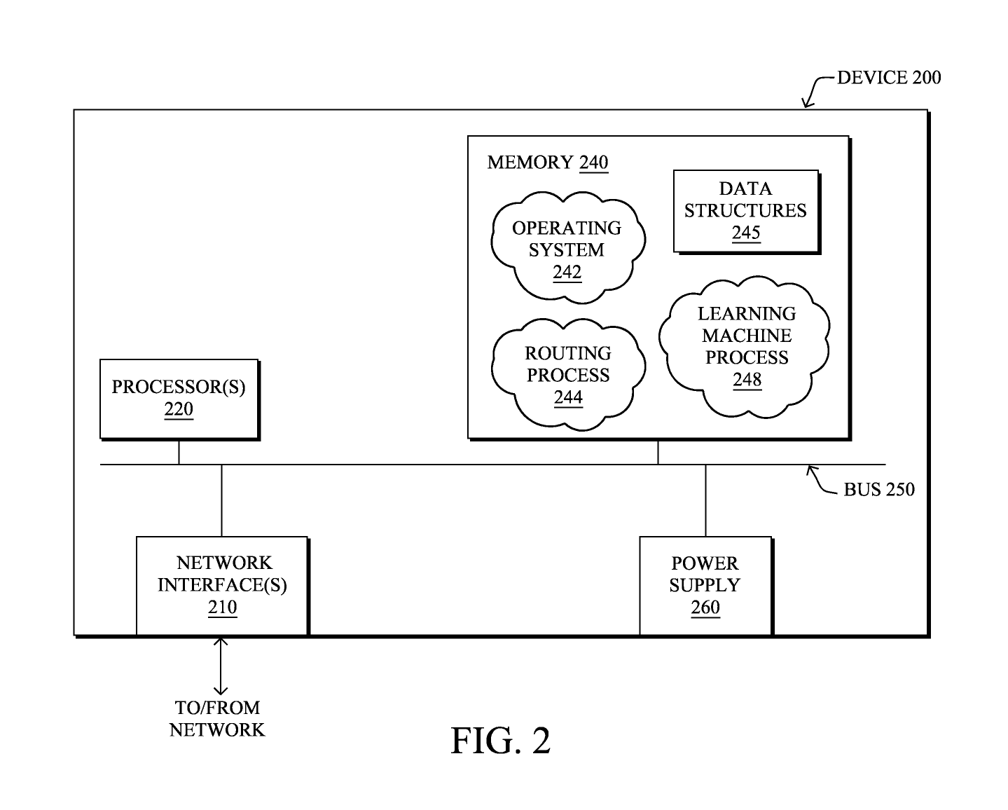

FIG. 1 is a schematic block diagram of an example computer network 100 illustratively comprising nodes/devices 110 (e.g., labeled as shown, “root,” “11, ” “12,” . . . “45,” and described in FIG. 2 below) interconnected by various methods of communication. For instance, the links 105 may be wired links or shared media (e.g., wireless links, PLC links, etc.) where certain nodes 110, such as, e.g., routers, sensors, computers, etc., may be in communication with other nodes 110, e.g., based on distance, signal strength, current operational status, location, etc. The illustrative root node, such as a field area router (FAR) of a FAN, may interconnect the local network with a WAN 130, which may house one or more other relevant devices such as management devices or servers 150, e.g., a network management server (NMS), a dynamic host configuration protocol (DHCP) server, a constrained application protocol (CoAP) server, etc. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure.

Data packets 140 (e.g., traffic and/or messages) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes or devices shown in FIG. 1 above. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC (where the PLC signal may be coupled to the power line feeding into the power supply) the network interface 210 may communicate through the power supply 260, or may be an integral component of the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise a routing process/services 244 and an illustrative “learning machine” process 248, which may be configured depending upon the particular node/device within the network 100 with functionality ranging from intelligent learning machine algorithms to merely communicating with intelligent learning machines, as described herein. Note also that while the learning machine process 248 is shown in centralized memory 240, alternative embodiments provide for the process to be specifically operated within the network interfaces 210.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 contains computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Notably, mesh networks have become increasingly popular and practical in recent years. In particular, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point such at the root node to a subset of devices inside the LLN) and multipoint-to-point traffic (from devices inside the LLN towards a central control point).

An example implementation of LLNs is an “Internet of Things” network. Loosely, the term “Internet of Things” or “IoT” (or “Internet of Everything” or “IoE”) may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example protocol specified in an Internet Engineering Task Force (IETF) Proposed Standard, Request for Comment (RFC) 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs), FARs, or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

Also, a directed acyclic graph (DAG) is a directed graph having the property that all edges are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Note also that a tree is a kind of DAG, where each device/node in the DAG generally has one parent or one preferred parent. DAGs may generally be built (e.g., by a DAG process and/or routing process 244) based on an Objective Function (OF). The role of the Objective Function is generally to specify rules on how to build the DAG (e.g. number of parents, backup parents, etc.).

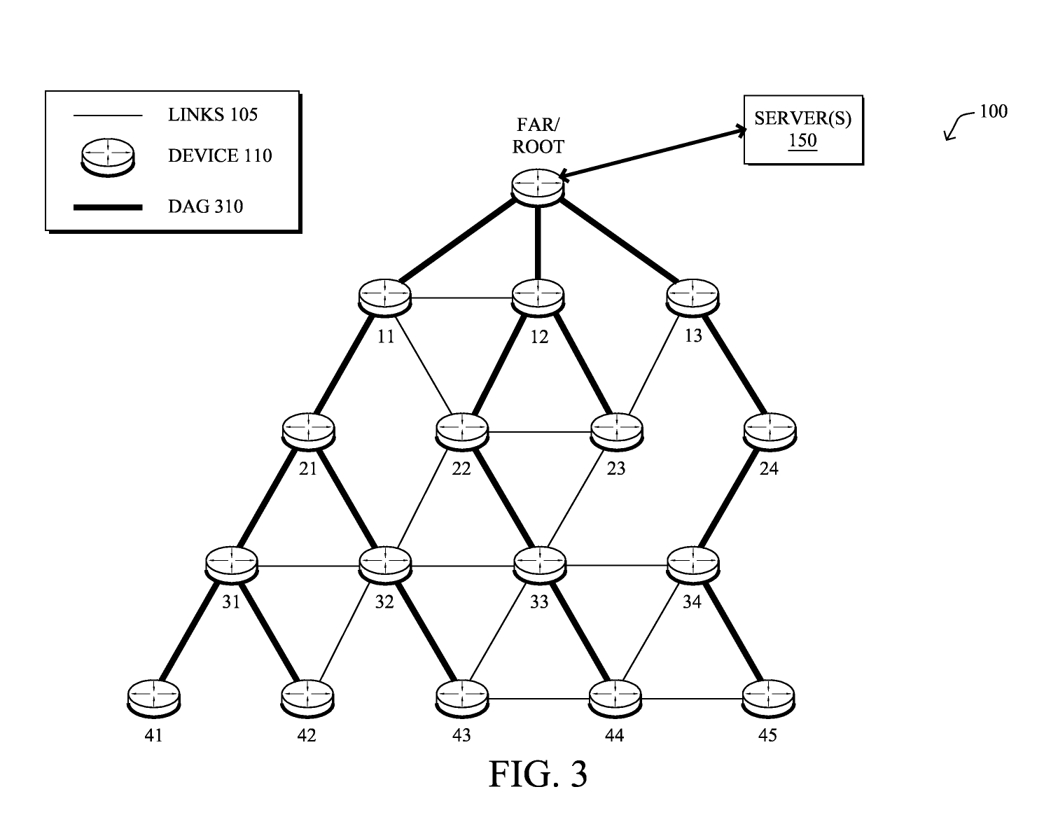

FIG. 3 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 310 (shown as bolded lines), which extends from the root node toward one or more leaf nodes (nodes without children). Traffic/packets 140 (shown in FIG. 1) may then traverse the DAG 310 in either the upward direction toward the root or downward toward the leaf nodes, particularly as described herein.

Learning Machine Technique(s)

As noted above, machine learning (ML) is concerned with the design and the development of algorithms that take as input empirical data (such as network statistics and state, and performance indicators), recognize complex patterns in these data, and solve complex problem such as regression thanks to modeling. One very common pattern among ML algorithms is the use of an underlying model M, whose parameters are optimized for minimizing the cost function associated to M, given the input data. For instance, in the context of classification, the model M may be a straight line that separates the data into two classes such that M=a*x+b*y+c and the cost function would be the number of misclassified points. The ML algorithm then consists in adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

As also noted above, learning machines (LMs) are computational entities that rely one or more ML algorithm for performing a task for which they haven't been explicitly programmed to perform. In particular, LMs are capable of adjusting their behavior to their environment. In the context of LLNs, and more generally in the context of the IoT (or Internet of Everything, IoE), this ability will be very important, as the network will face changing conditions and requirements, and the network will become too large for efficiently management by a network operator. Thus far, LMs have not generally been used in LLNs, despite the overall level of complexity of LLNs, where “classic” approaches (based on known algorithms) are inefficient or when the amount of data cannot be processed by a human to predict network behavior considering the number of parameters to be taken into account.

Most LM algorithms can be proved to converge to some local optimum of the solution space (i.e., they will not simply diverge and instead exhibit random and non-favorable performance). However, most LM algorithms are not capable of ensuring that they converged to the global optimum. When the findings of these algorithms are used for making critical decisions (e.g., adjusting network parameters, triggering global repairs in RPL, triggering node reboots, etc.), their reliability, and more specifically their lack thereof, might preclude the deployment of such technologies in the context of highly sensitive systems such as smart grids. Note that a local optimum may translate into a wrong decision, not just a sub-optimal decision in some (not common) circumstances.

Another phenomenon observed in LM algorithms is over-confidence, which is often observed in algorithms such as Kalman or particle filters. In general, many probabilistic algorithms may converge quickly to a solution, thereby limiting their search to a very limited region of the solution space. However, in very dynamic scenarios where the actual solution is constantly evolving, this phenomenon may lead to situations in which the algorithm is very certain about a solution that is actually wrong. In such situations, one may explicitly decrease the confidence of the algorithm about its result, thereby allowing it to explore the solution space again.

Another issue that may arise when LM mechanisms are in play is the occurrence of an event leading to a reaction by the LM that can cause unfavorable conditions in the network. When this happens, there is a requirement for a mechanism to be able to revert the conditions to that of more stability.

The techniques herein, therefore, increase the reliability of LM algorithms by mitigating the impact of the above phenomena using a combination of LM algorithms (e.g., Bayesian methods, ensemble strategies, and external triggers (e.g., user feedback). For the purposes of the present disclosure, the local and external algorithms may be referred to as “reliability checking algorithms.” The techniques herein also implement a series of counter-measures that may be exploited upon detecting a lack of reliability. In particular, the techniques herein introduce a series of mechanisms for detecting and addressing issues related to the reliability of LMs in LLNs. Specifically, two local algorithms may be used based on Bayesian and ensemble methods, as well as an external mechanism based on user feedback. A monitoring agent fed by local algorithm used to evaluate the performance of the LM or user feed-back is used to send “red flag” messages to the learning machine. The rate at which such red flag messages are received by the LM is used in order to determine the action to take that can range from stopping an LM, resetting a confidence level, or using multiple algorithms on identical datasets in order to evaluate the respective performance of each algorithm.

In one embodiment, network data is processed using a Learning Machine (LM) algorithm in a network, and results of the processing of network data are determined. A reliability checking algorithm is selected to determine a reliability level of the results. The reliability checking algorithm may be a local reliability checking algorithm or an external reliability checking algorithm. The reliability level of the results is determined using the reliability checking algorithm. Then, the LM algorithm is adjusted based on the determined reliability level.

Illustratively, the techniques described herein may be performed by hardware, software, and/or firmware, such as in accordance with the learning machine process 248, which may contain computer executable instructions executed by the processor 220 (or independent processor of interfaces 210) to perform functions relating to the techniques described herein, e.g., optionally in conjunction with other processes. For example, certain aspects of the techniques herein may be treated as extensions to conventional protocols, such as the various communication protocols (e.g., routing process 244), and as such, may be processed by similar components understood in the art that execute those protocols, accordingly. Also, while certain aspects of the techniques herein may be described from the perspective of a single node/device, embodiments described herein may be performed as distributed intelligence, also referred to as edge/distributed computing, such as hosting intelligence within nodes 110 of a Field Area Network in addition to or as an alternative to hosting intelligence within servers 150.

Operationally, a first component of the techniques herein is the local algorithm. The primary methods for performing the local algorithm may include, for example, Bayesian and ensemble methods, of which any combination or amount of the methods may be employed. Each of these approaches provides a notion of confidence, that is, a measure of how confident the LM is with respect to its predictions or its decisions. Bayesian methods use the well-known Bayes law for tracking the distribution of random variables in a statistical model. Owing to the fact that the whole distribution is captured, one has a sense of whether the estimate of the underlying quantity is very accurate or not. Ensemble strategies consist in using several learning algorithms for solving the same problem, and then take a vote of their predictions. Again, by comparing the various votes, one may get a sense of whether the confidence is high (nearly unanimous vote) or rather low (very disparate votes). The local algorithm therefore involves using the results obtained by running several LM algorithms on the same set of state values, e.g., “network data,” obtained and then triggering a confidence check based on their output.

A second aspect of the techniques herein is the external algorithm. In this case, a human expert, e.g., user, may provide feedback to the LM regarding its performance using red flag packets sent over a dedicated communication channel established between them. To that end, the techniques herein specify a newly defined unicast IPv6 message called RF (Red Flag) comprising a set of parameters (TLVs) used by the learning machine to be informed of an incorrect behavior. Red flag messages are sent to the LM whenever an expert has detected an inappropriate behavior or decision taken by it. In one embodiment, an RF message may contain details of the reaction that was taken by the LM as well as what should be done to rectify it and bring back favorable performance.

Based on this input by the expert, the LM decides the triggering of counter-measures using two main criteria: criticality (i.e., how critical is the output of the LM with respect to the network operation) and the rate of red flag packets (i.e., how reliable and exact is the output of the LM according to the user). Note that the techniques herein may allow a LM to be slightly inaccurate (i.e., getting a few red flag packets from time to time) if its output is not critical. However, in very critical scenarios, one may want to take counter-measures as soon as one red flag packet is received.

A third aspect of the techniques herein is directed to the counter measures that can be taken if the confidence is below a given threshold. First, in the case of a local trigger, it may mean that the LM has simply not been able to find a good solution yet. One potential counter-measure is then to reset the LM and start the learning process again, with the hope that the new initial conditions and the new input data will help find a better solution. At the same time, all details of the current state may be kept so it can be compared with the new converged state of the LM. Another more definitive counter-measure is to switch to a different algorithm that solves the same type of problems.

More specifically, the techniques herein specify a monitoring system hosted on a server, in charge of sending RF messages. The monitoring system can be fed by a number of sources: a local engine used to identify improper learning machine based decisions or, as specified above, user-based inputs. The rate at which RF messages are received by the LM is then used to determine which action should be taken:

```
  IF number of RF messages > K1 THEN stop the LM;
  IF K2 < number of RF messages < K1 THEN stop start to use the
ensemble approach or another pre-determined method (using an additional,
different LM locally or remotely);
  IF number of RF messages < K3 THEN continue.
```

According to the techniques herein, a newly defined message may be used by the NMS to specify to the LM the set of values for K1, K2, K3, etc., along with the appropriate actions. Although these parameters may be locally configured, they may also be dynamically determined by the NMS or a performance monitoring agent.

Note that a mix of local and external trigger can be used. For example, if local triggers result in the LM ensemble coming up with differing results, a human expert can intervene and select the LM algorithm to switch to after carefully evaluating all the results of the different LMs. Indeed, some algorithms may perform quite differently in different scenarios, and changing the algorithm may help in some situations. In the case of an external trigger, the same counter-measures as above apply, but one may use a more adaptive mechanism as well, that is, the confidence of the LM may artificially decreased in order to mitigate the phenomenon of over-confidence.

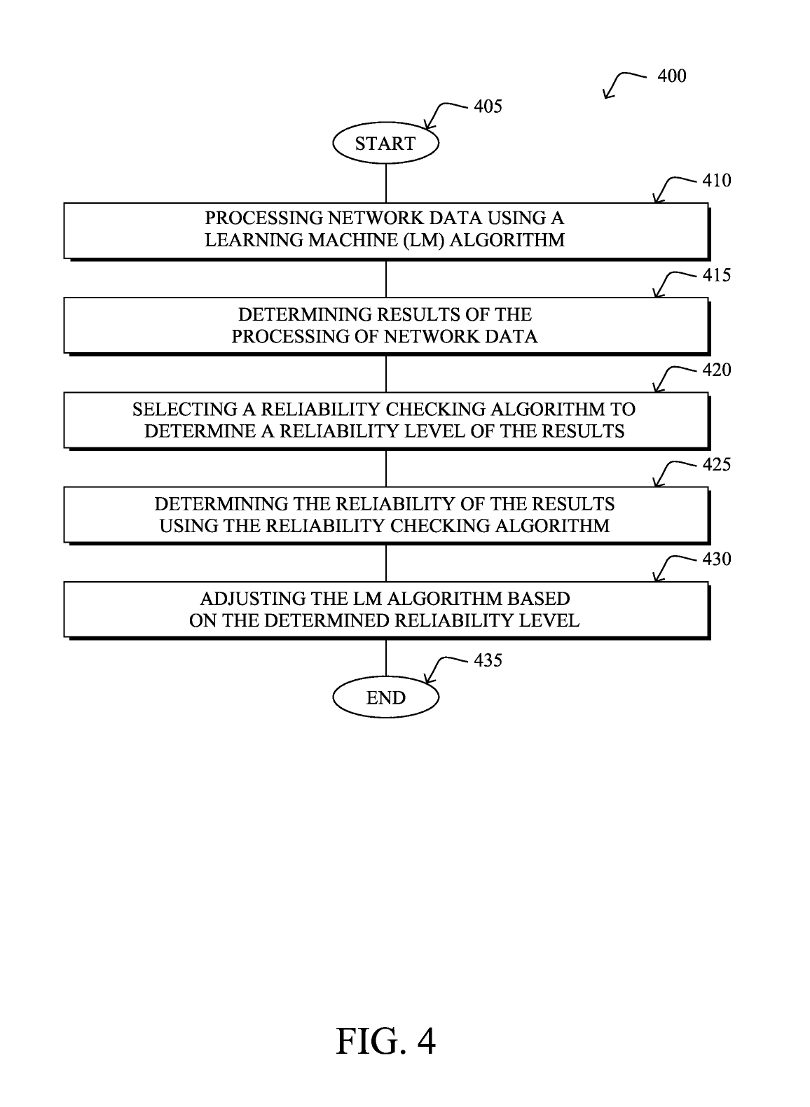

FIG. 4 illustrates an example simplified procedure for enhancing the reliability of learning machines in computer networks. As shown in FIG. 4, the procedure 400 may start at step 405, continue to step 410, and so forth, where, as described in greater detail above, a reliability level of an LM algorithm may be evaluated and improved.

At Step 410, the procedure 400 includes processing network data using an LM algorithm in a network. At Step 415, results of the processing of network data are determined. Next, at Step 420, a reliability checking algorithm is selected to determine a reliability level of the results. The reliability checking algorithm may be a local reliability checking algorithm or an external reliability checking algorithm. At Step 425, the reliability level of the results is determined using the reliability checking algorithm. At Step 430, the LM algorithm is then adjusted based on the determined reliability level.

The procedure 400 illustratively ends in step 435. The techniques by which the steps of procedure 400 are performed, as well as ancillary procedures and parameters, are described in detail above.

It should be understood that the steps shown in FIG. 4 are merely examples for illustration, and certain steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for enhancing the reliability of learning machines in computer networks. In particular, the techniques herein enhance the reliability of LMs by preventing over confidence and convergence on inaccurate values, while also enhancing the functionality of LMs using a feedback loop mechanism with human experts where human knowledge is communicated with the LM to validate or invalidate its reactions. Further, the techniques herein provide the ability to switch between LMs using human input for better performance.

While there have been shown and described illustrative embodiments that provide for enhancing the reliability of learning machines in computer networks, it is to be understood that various other adaptations and modifications may be made within the spirit and scope of the embodiments herein. For example, the embodiments have been shown and described herein with relation to LLNs and related protocols. However, the embodiments in their broader sense are not as limited, and may, in fact, be used with other types of communication networks and/or protocols. In addition, while the embodiments have been shown and described with relation to learning machines in the specific context of communication networks, certain techniques and/or certain aspects of the techniques may apply to learning machines in general without the need for relation to communication networks, as will be understood by those skilled in the art.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
processing network data using a Learning Machine (LM) algorithm in a network;
determining results of the processing of network data;
selecting a reliability checking algorithm to determine a reliability level of the results, the reliability checking algorithm being a local reliability checking algorithm or an external reliability checking algorithm;
determining the reliability level of the results using the reliability checking algorithm; and
adjusting the LM algorithm based on the determined reliability level.

2. The method according to claim 1, further comprising:
receiving one or more feedback messages indicating an improper operation of the LM algorithm.

3. The method according to claim 1, wherein the adjusting of the LM algorithm is based further on the one or more feedback messages.

4. The method according to claim 1, further comprising:
performing a counter-measure to increase the reliability level.

5. The method according to claim 4, further comprising:
determining whether the reliability level is below a predetermined threshold, wherein the counter-measure is performed when the reliability level is below the predetermined threshold.

6. The method according to claim 4, wherein the performing of the counter-measure is triggered by one of: a criticality of one or more feedback messages and a rate of receipt of one or more feedback messages.

7. The method according to claim 4, wherein the counter-measure includes one of:
resetting the LM algorithm and processing the network data using a new LM algorithm.

8. The method according to claim 2, wherein the one or more feedback messages are generated by a user.

9. The method according to claim 2, further comprising:
when a number of received feedback messages is greater than a predetermined first threshold, terminating the LM algorithm.

10. The method according to claim 9, further comprising:
when the number of received feedback messages is greater than a predetermined second threshold and less than the predetermined first threshold, processing the network data using a new LM algorithm.

11. The method according to claim 10, further comprising:
receiving a message indicating the predetermined first threshold and the predetermined second threshold.

12. An apparatus, comprising:
one or more network interfaces that communicate with a network;
a processor coupled to the one or more network interfaces and configured to execute a process; and
a memory configured to store program instructions which contain the process executable by the processor, the process comprising:
processing network data using a Learning Machine (LM) algorithm in the network;
determining results of the processing of network data;
selecting a reliability checking algorithm to determine a reliability level of the results, the reliability checking algorithm being a local reliability checking algorithm or an external reliability checking algorithm;
determining the reliability level of the results using the reliability checking algorithm; and
is adjusting the LM algorithm based on the determined reliability level.

13. The apparatus according to claim 12, wherein the process further comprises:
receiving one or more feedback messages indicating an improper operation of the LM algorithm.

14. The apparatus according to claim 12, wherein the adjusting of the LM algorithm is based further on the one or more feedback messages.

15. The apparatus according to claim 12, wherein the process further comprises:
performing a counter-measure to increase the reliability level.

16. The apparatus according to claim 15, wherein the process further comprises:
determining whether the reliability level is below a predetermined threshold, wherein the counter-measure is performed when the reliability level is below the predetermined threshold.

17. The apparatus according to claim 15, wherein the performing of the counter-measure is triggered by one of: a criticality of one or more feedback messages and a rate of receipt of one or more feedback messages.

18. The apparatus according to claim 15, wherein the counter-measure includes one of:
resetting the LM algorithm and processing the network data using a new LM algorithm.

19. The apparatus according to claim 13, wherein the one or more feedback messages are generated by a user.

20. The apparatus according to claim 13, wherein the process further comprises:
when a number of received feedback messages is greater than a predetermined first threshold, terminating the LM algorithm.

21. The apparatus according to claim 20, wherein the process further comprises:
when the number of received feedback messages is greater than a predetermined second threshold and less than the predetermined first threshold, processing the network data using a new LM algorithm.

22. The apparatus according to claim 21, wherein the process further comprises:
receiving a message indicating the predetermined first threshold and the predetermined second threshold.

23. A tangible non-transitory computer readable medium storing program instructions that cause a computer to execute a process, the process comprising:
processing network data using a Learning Machine (LM) algorithm in a network;
determining results of the processing of network data;
selecting a reliability checking algorithm to determine a reliability level of the results, the reliability checking algorithm being a local reliability checking algorithm or an external reliability checking algorithm;
determining the reliability level of the results using the reliability checking algorithm; and
adjusting the LM algorithm based on the determined reliability level.
